(19) United States
(12) Patent Application Publication
(10) Pub. No.: US 2003/0052913 A1
(43) Pub. Date: Mar. 20, 2003

(54) Method and apparatus to supply relevant media content

(76) Inventor: Steven E. Barile, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/957,594

(22) Filed: Sep. 19, 2001

(51) Int. Cl. G09G 5/00

(52) U.S. Cl. 345/745

(57) ABSTRACT

Supplying relevant content to a media consumer includes analyzing a play list of media titles and a profile of the media consumer, and modifying the play list by inserting a reference to content into the play list, the content selected according to the media consumer profile and at least one of a first media title immediately preceding the reference to the content in the play list, and a second media title immediately following the reference to the content in the play list. Insertion of the relevant content may be accepted by the media consumer in return for value.

### FIELD

The present invention relates to the field of supplying media content to a consumer. More particularly, but not exclusively, the present invention relates to supplying media content relevant to the consumer's play list and profile.

### BACKGROUND

It is common today for people to access digital music, video, and other content online (e.g., over a network), using computers or other devices such as portable digital music players. A play list may be used to organize content. A play list typically includes references to content, which may be accessed or retrieved online or stored locally by the device that renders the content. The references to the content are sometimes referred to as media titles. When the content identified by the media titles is available by way of the Internet, the media titles typically includes Uniform Resource Locators (URLs) identifying where the content may be found. The content itself is usually stored digitally in the form of media files (e.g., in the Moving Pictures Expert Group (MPEG) video or MP3 audio formats), which may be downloaded or streamed from a server device to the device that renders the content, sometimes called the client device.

It is also common for servers that are accessed by multiple parties to store profile information for the parties. For example, many servers of the Internet used for electronic commerce store profile information about the consumption habits and demographics of online shoppers. These profiles are typically called consumer profiles.

U.S. Pat. No. 6,038,591 (the '591 patent) describes a method to identify advertising content relevant to a song according to a user profile. However, the approach taught by the '591 patent does not take advantage of the information provided by the contents of a play list. Furthermore, the method of '591 does not provide for the media consumer to have control over acceptable temporal locations for the insertion of advertising or other content into their content consumption experience. The method of '591 has a further drawback in that it involves appending the content of song files with the content of advertising files, which is resource-intensive and not easily adapted to mixed media types (song files and non-audio content such as video or text).

### FIGURES

The invention may be better understood with reference to the following figures in light of the accompanying description. The present invention, however, is limited only by the scope of the claims at the concluding portion of the specification.

FIG. 1 shows an embodiment of a system in accordance with the present invention.

FIG. 2 shows an embodiment of a client device in accordance with the present invention.

FIG. 2A shows a more detailed block diagram of a client device in accordance with an embodiment of the present invention.

FIG. 3 shows an embodiment of a server in accordance with the present invention.

FIG. 3A shows a more detailed block diagram of a server in accordance with an embodiment of the present invention.

FIG. 4 shows an embodiment of a server in accordance with the present invention.

FIG. 4A shows a more detailed block diagram of a server in accordance with an embodiment of the present invention.

FIG. 5 shows an embodiment of a server in accordance with the present invention.

FIG. 5A shows a more detailed block diagram of a server in accordance with an embodiment of the present invention.

FIG. 6 shows a process embodiment in accordance with the present invention.

### DETAILED DESCRIPTION

In the following description, references to “one embodiment” or “an embodiment” do not necessarily refer to the same embodiment, although they may. Various operations of the description below and the claims are described in terms of software, e.g., instructions executed by a processor, either a general purpose processor, or a more task-specific processor such as an embedded processor or digital signal processor. However, the various operations may of course be embodied by software, hardware, firmware, or a combination thereof.

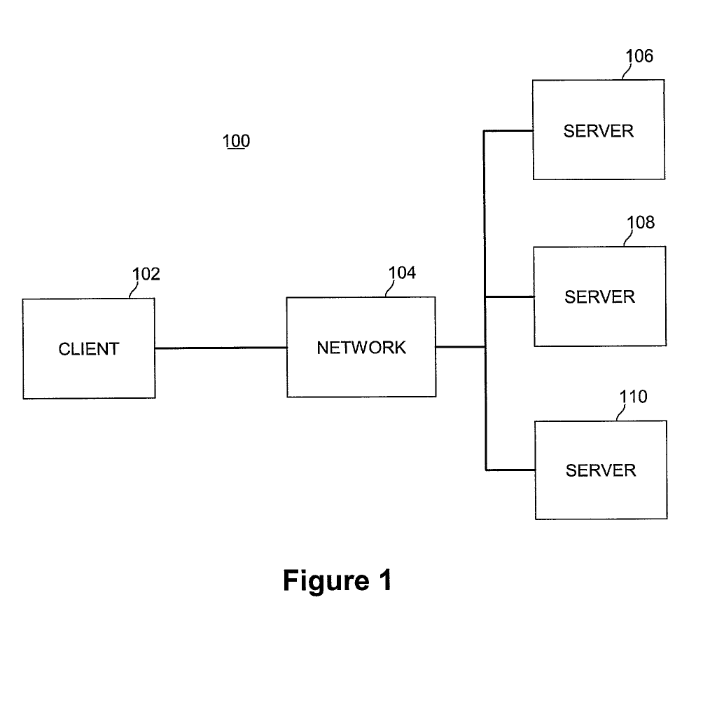

FIG. 1 shows an embodiment 100 of a system in accordance with the present invention. A client device 102 is coupled to a plurality of servers 106, 108, 110 by way of a network 104. The client 102 may comprise one of many types of known data processing devices including, but not limited to, a personal computer (PC), a handheld computer, a portable digital music player, a laptop computer, a set-top box, a personal digital assistant (PDA), a cell phone, and so on. In general, the client 102 may comprise any device having a processor, and a memory to supply instructions and data to the processor. Client 102 may also comprise media rendering capabilities, such as a display to render images and video, and speakers to render audio.

The network 104 may comprise various technologies for coupling client 102 to a plurality of servers. The Internet is one example of a network. Other examples include corporate intranets, satellite and other wireless networks, and telephone networks. The servers 106, 108, 110 provide signals, usually representing data or software, to the client 102 in response to requests from the client 102. According to one embodiment, one of the plurality of servers may store a profile of a media consumer who operates the client 102. Another of the plurality of servers may store media files that may be provided to the client 102 and rendered thereby. Another server of the plurality of the servers may operate to modify a play list of the media consumer according to acceptable insertion points in the play list, and further according to the contents of the play list and the user profile.

Of course, a single server could comprise all of the functionality of the separate servers described above. In fact, any combination of any number of servers in various arrangements could be employed to the same effect, according to a given implementation. In one embodiment, an operator of the server desiring to modify the play list may provide value (e.g., cash, discounts, promotional goods, and so on) to the operator of the server storing the play list and/or the profile for the right to modify the play list of the media consumer.

When a media consumer of the client 102 wishes to consume or otherwise experience media content, the consumer may cause the client 102 to receive media content according to a play list. The play list comprises a plurality of references to media files to be rendered at the client. The client 102 may comprise media player functionality that may operate to identify, locate, and receive media files identified by media titles 312 comprised by the play list 302. The content of the media files may be accessed locally or received from servers and rendered by the media player for the benefit of the media consumer. The play list may be stored in a non-volatile fashion by the client 102 (e.g., using a non-volatile memory comprised by the client, such as a hard disk), or the play list may be stored on a server in a non-volatile fashion and retrieved (e.g. down loaded from the server) to the volatile memory of the client 102. The manner and location at which the play list is stored is an implementation choice.

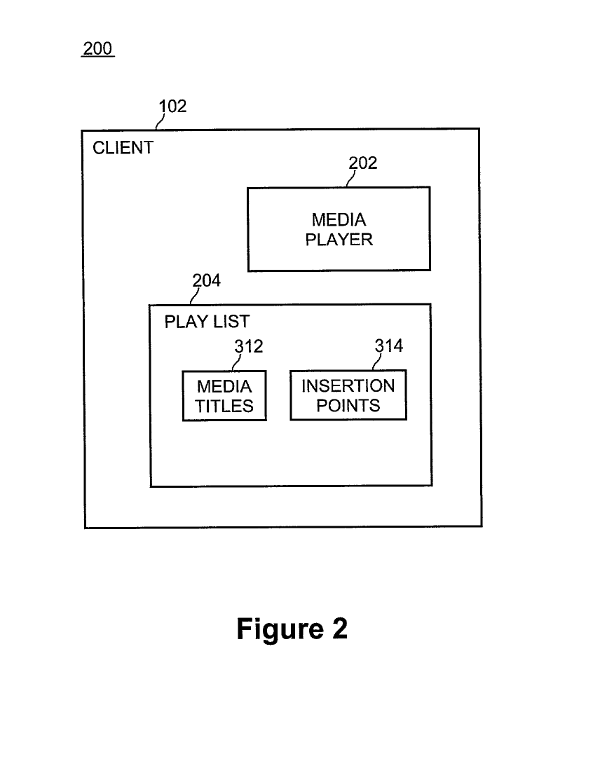

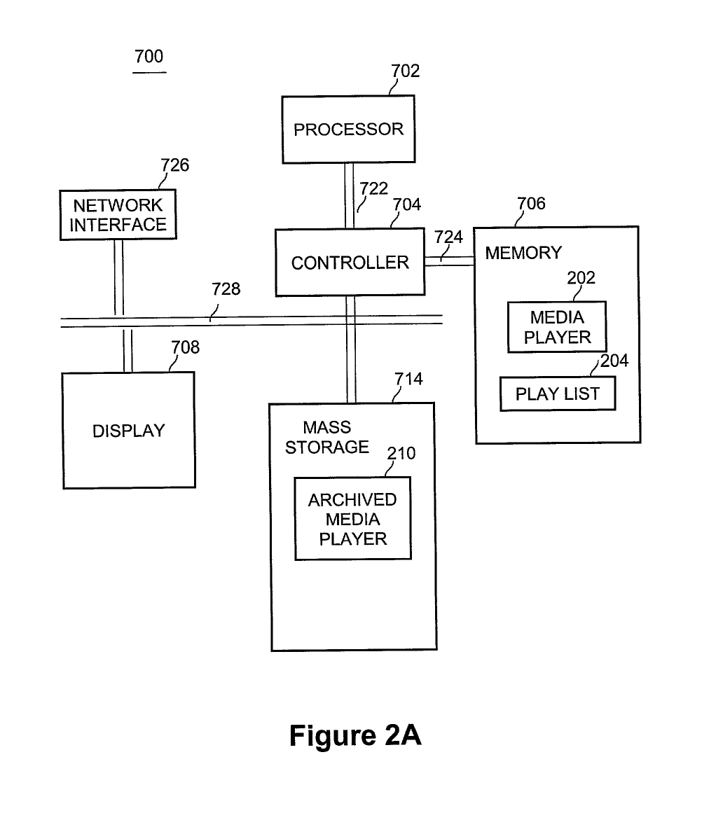

FIG. 2 shows an embodiment 200 of a client 102 in accordance with the present invention. The client 102 comprises media player functionality 202 that in some embodiments comprises a software program executing on a general purpose processor. Examples of such embodiments include the RealPlayer® media player of RealNetworks®, of Seattle, Wash., and the Windows Media Player® media player of Microsoft® Corporation, Redmond, Wash., although the invention is not limited in this respect. In other embodiments, the media player functionality 202 may comprise firmware of a non-volatile memory, such as flash memory or read-only memory. Media player functionality may also comprise a combination of firmware, software, and circuitry. Such embodiments may be found in portable digital music players. Generally, the media player obtains, reads, processes, and renders multimedia digital content.

Client 102 may further comprise a play list 204. As previously noted, the client 102 may store the play list in a non-volatile memory, or in a volatile memory such as random access memory upon receiving the play list from a server. The play list 204 may comprise media titles 312 identifying media files that a media consumer who operates the client 102 may wish to consume, render, or otherwise experience. Media titles may comprise any multimedia content such as audio data (e.g., digital music tracks in any format, including MP3, digital versatile disk (DVD)-audio or other format), video data, image data, graphics data, animation data, music data such as songs, and so on. The play list 204 may further comprise acceptable insertion points 314 at which references to other, additional content may be inserted. In this manner, the media consumer may control at which points in the play list references to additional content are inserted. In some cases, the insertion points could identify unacceptable insertion points as well, and acceptable insertion points could be inferred from these. The media player functionality 202 may operate to retrieve and render the content identified in the play list 204. In one embodiment, the media consumer defines the insertion points.

FIG. 2A shows a more detailed block diagram of an embodiment 700 of a client 102 in accordance with the present invention. Embodiment 700 comprises a processor 702 coupled to a controller 704 by way of a processor bus 722, commonly referred to as a front side bus. Bus controller 704 is coupled to memory 706 via memory bus 724. Bus controller 704 is also coupled to various peripheral devices such as mass storage 714, network interface 726, and display 708 via I/O bus 728. Network interface 726 provides device 700 with access to networks such as the Internet or corporate intranets. Memory 706 stores a software embodiment 202 of a media player in accordance with the present invention. Memory 706 also stores a play list embodiment 204. Media player 202 may be stored in memory 706 in a form suitable for access and execution by processor 702. An archived loadable form 210 of media player 202 may be stored by mass storage 714 for loading into memory 706 for execution by processor 702. Mass storage 714 may comprise any form of non-volatile memory including hard drives, CD ROM drives, ZIP drives, diskettes, and so on.

Memory 706 is typically a form of random access memory (RAM) such as a DRAM, flash memory, SDRAM, and so on. Memory 706 supplies the instructions of software 202 stored therein to processor 702 for execution.

Those skilled in the art will appreciate that other embodiments could comprise different combinations of software, hardware, and firmware than those illustrated to carry out the operations of the present invention as well.

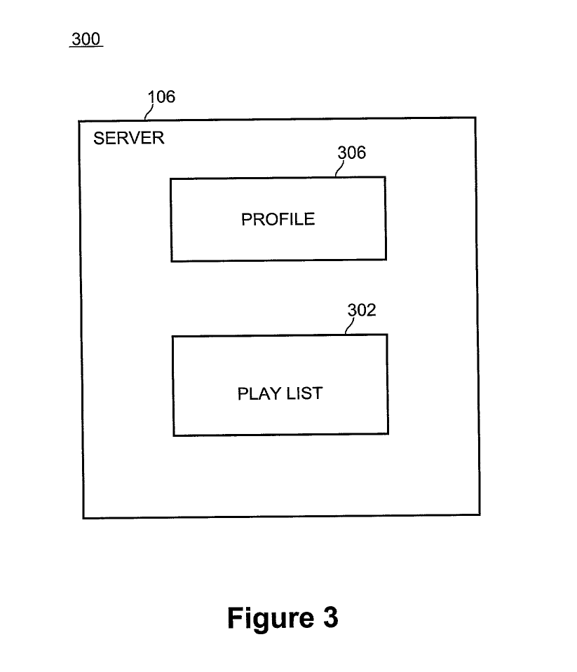

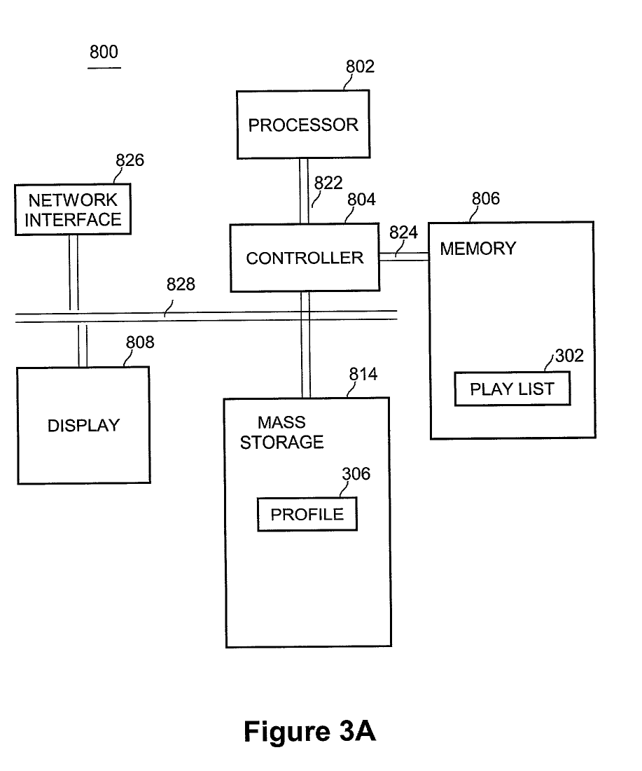

FIG. 3 shows an embodiment 300 of a server 106 in accordance with the present invention. In this embodiment, the server 106 stores the play list 302. The play list 302 may be provided by the client 102 to the server 106, or the server may store the play list 302 and provide a copy to the client 102. The server 106 further comprises a profile 306 of the media consumer who operates the client 102. In a manner to be described and in accordance with embodiments of the present invention, the contents of the play list may be modified according to at least: 1) the content of the play list 302; 2) the profile 306; and 3) acceptable insertion points provided by the media consumer. While the exemplary embodiment describes a play list 302 with insertion points 314 provided by the media consumer, in alternate embodiments another party, for example the operator of server 106, may provide the insertion points. In one embodiment, determination of an acceptable or appropriate insertion point may be made by analyzing the media title in the play list immediately before the insert point and immediately after the insertion point.

FIG. 3A shows a more detailed block diagram of the server 106 in accordance with one embodiment of the present invention. Embodiment 800 comprises a processor 802 coupled to a controller 804 by way of a processor bus 822, commonly referred to as a front side bus. Bus controller 804 is coupled to memory 806 via memory bus 824. Bus controller 804 is also coupled to various peripheral devices such as mass storage 814, network interface 826, and display 808 via I/O bus 828. Network interface 826 provides device 800 with access to networks such as the Internet or corporate intranets. Memory 806 stores a play list embodiment 302. Mass storage 814 stores the profile 306 that may be loaded to memory 806 and accessed by processor 802. Mass storage 814 may comprise any form of non-volatile memory including hard drives, CD ROM drives, ZIP drives, diskettes, and so on.

Memory 806 is typically a form of random access memory (RAM) such as a DRAM, flash memory, SDRAM, and so on. Memory 806 supplies data and instructions to processor 802 for execution.

Those skilled in the art will appreciate that other embodiments could comprise different combinations of software, hardware, and firmware than those illustrated in embodiment 800.

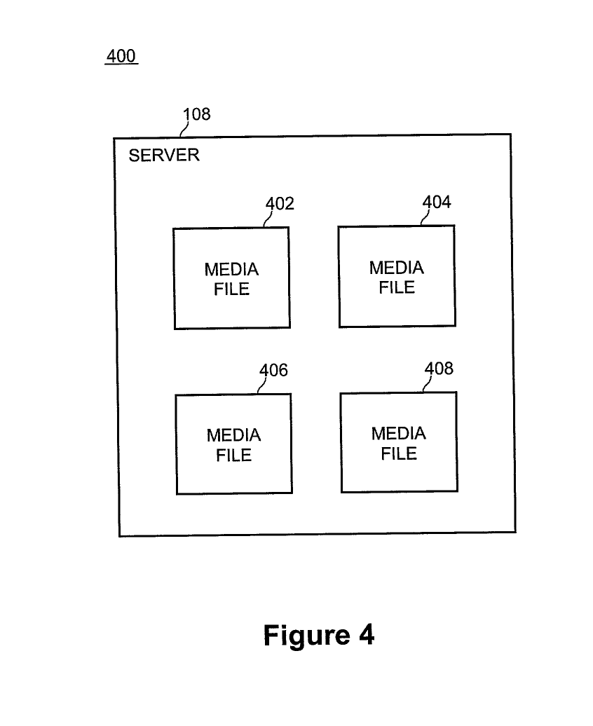

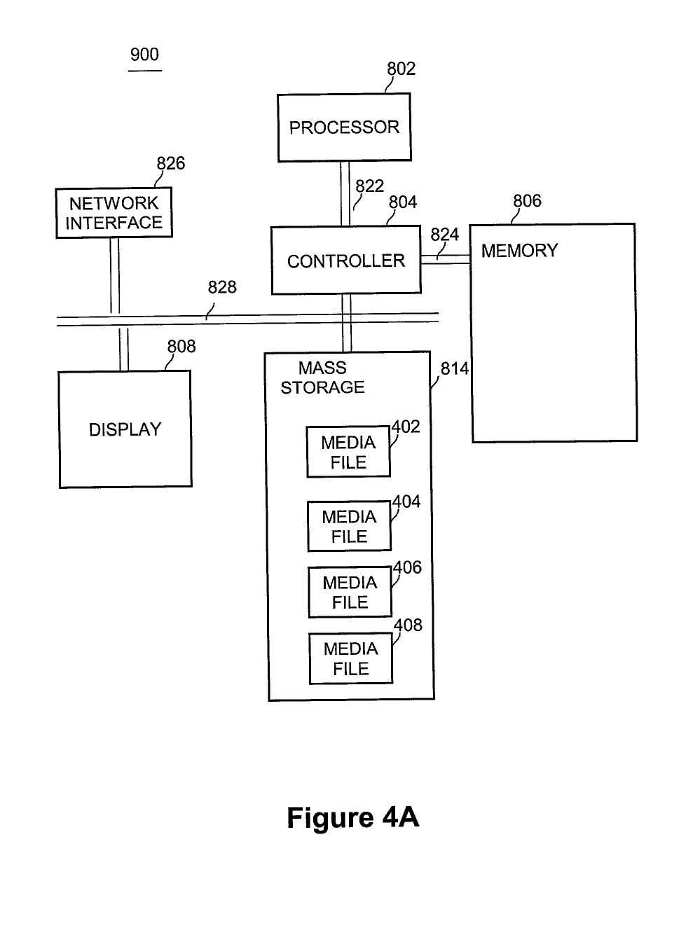

FIG. 4 shows an embodiment 400 of a server 108 in accordance with the present invention. The server 108 stores a plurality of media files 402-408, typically in a non-volatile fashion. The media files 402-408 may correspond to one or more of media titles 312 comprised by the play list 302, or other predetermined content. The content of the media files identified in the play list 302 may be transferred to the client 102 and thereby rendered by the media player 202. The server 108 may sometimes be referred to as a “media server”, “video server”, or “audio server”.

FIG. 4A shows a detailed block diagram of one embodiment 900 of server 108 in accordance with the present invention. The embodiment 900 comprises many components with functionality that is similar or identical to the functionality of the server embodiment 800. Like numbers represent components with like functionality. In the embodiment 900, the mass storage 814 stores the media files 402-408 which may be loaded to memory 806 and accessed by processor 802.

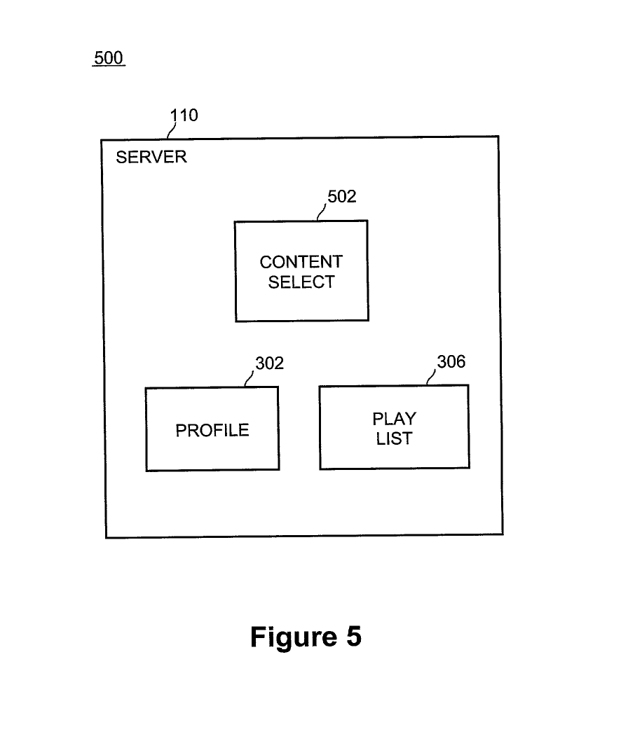

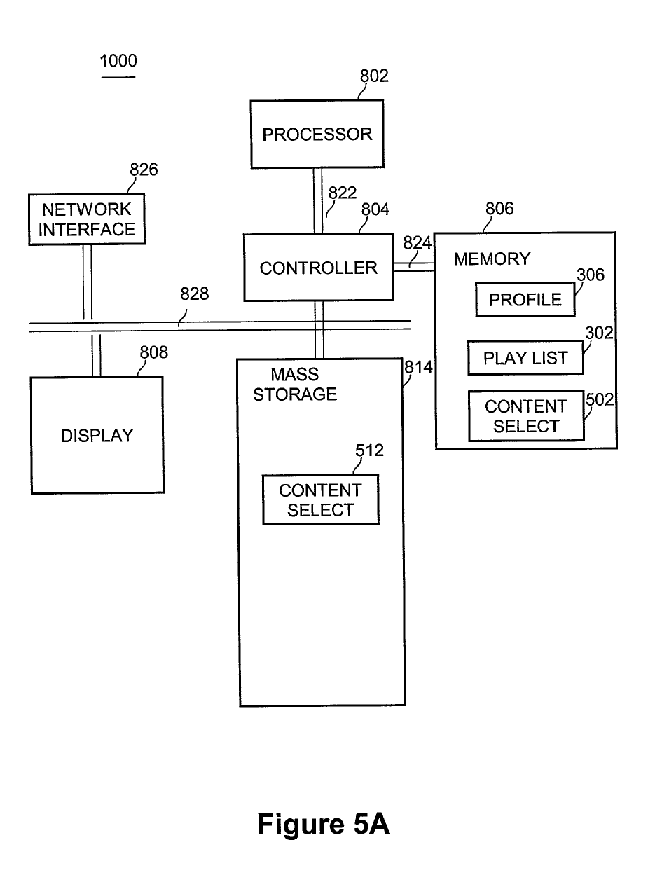

FIG. 5 shows an embodiment 500 of a server 110 in accordance with the present invention. The server 110 comprises content selection functionality 502 to receive the play list 302 and the profile 306 from server 106. The content selection functionality 502 may analyze the contents of the play list 302 and the profile 306 to identify content relevant thereto. The content selection functionality 502 may modify the play list 302 to include a reference to the identified content. The reference to the identified content may be inserted into the play list 302 at a location in accordance with the acceptable insertion points 314 provided by the media consumer as part of the play list 302. The reference to the content may identify one of the media files 402-408 accessible from server 108. The reference could identify content including, for example, songs, advertisements, current news stories, video clips, animations, text, and so on.

In one embodiment, the reference may identify a song that an operator of server 110 wishes to promote. By analyzing the contents of the media consumer's play list 302 and profile 306, the operator may be able to target media consumers who have previously expressed an interest in the type of song, musical genre, type of news item, or other content that the operators desires to promote. In one embodiment, the profile comprises user preferences for type of song, musical genre, type of news item, or other content preferences and consumer interests. For example, the profile might include user preferences for pop music, sports scores and news items for certain sports teams, weather reports for certain cities, quotes for selected stocks, favorite hobbies, educational experiences, and so on. By analyzing the profile, a server operator may focus content to be inserted into the play list according to the kinds of content the media consumer likes and would like to receive during playback of the play list.

The modified play list 302 may be provided to the server 106, from which it may be provided to the client 102. An exchange of value may take place between the operator of the server 106 and the operator of the server 108, for granting the operator of server 108 the privilege of modifying the play list 302 to promote their content. In alternate embodiments the modified play list 302 may be provided by the server 110 directly to the client 102.

FIG. 5A shows a detailed block diagram of one embodiment 1000 of the server 110 in accordance with the present invention. The embodiment 1000 comprises many components with functionality that is similar or identical to the functionality of the server embodiments 800 and 900. Like numbers represent components with like functionality. In the embodiment 1000, the mass storage 814 stores an archived version 512 of the content selection functionality 502 that may be loaded to memory 806 and accessed by processor 802. The memory stores a software embodiment of the content selection functionality 502, as well as embodiments of the play list 302 and profile 306.

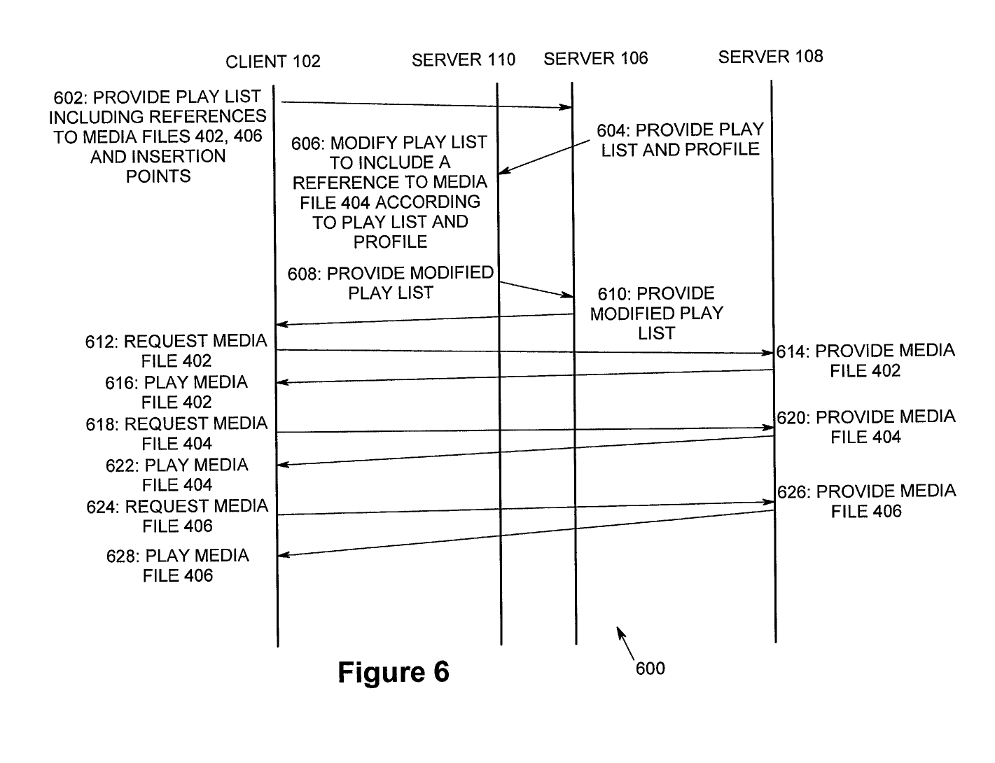

FIG. 6 shows a process embodiment in accordance with the present invention. At 602, the client 102 provides a play list of a media consumer to the server 106. The play list includes references to one or more media files, available either locally or via a network such as the Internet. For example, the play list may include references to at least the media files 402 and 406 accessible by server 108. The play list also includes acceptable temporal insertion points where references to other content may be inserted into the play list. At 604, the server 106 provides the play list and a profile of the media consumer to the server 110. The server 110 analyzes the play list and the consumer profile and identifies media file 404 as comprising content that is similar or somehow relevant to the media files 402 and 406, and the consumer profile. The server 110 also checks whether the slot between the references to media files 402 and 406 in the play list is one of the acceptable insertion points identified in the play list. If the slot is acceptable, a reference to media file 404 is inserted between the references to the media files 402 and 406. At 608, the modified play list is provided to the server 106.

At 610, the modified play list is provided to the client 102. The client 102 then begins retrieval and rendering of the content identified in the play list. At 612, the client 102 requests the content of the media file 402 according to the modified play list. At 614, the server 108 provides the media file 402 to the client 102 for rendering. At 616, the client 102 renders the media file 402. At 618, the client 102 requests the content of the media file 404 according to the modified play list. At 620, the server 108 provides the media file 404 to the client 102 for rendering. At 622, the client 102 renders the media file 404. At 624, the client 102 requests the content of the media file 406, according to the modified play list. At 626, the server 108 provides the media file 406 to the client 102 for rendering. At 628, the client 102 renders the media file 406.

The actions of servers 106, 108, and 110 are described independently above, however, one skilled in the art will readily understand that the actions of any or all of the servers may be combined and performed at one or more servers.

By utilizing embodiments of the present invention, a provider of additional content such as songs, advertisements, current news stories, video clips, animations, text, and the like, may insert such content into appropriate and authorized points in the play list of a media consumer. In one embodiment, the media consumer may be offered something of value (e.g., cash, product and service discounts, etc.) in return for agreeing to accept the additional content into the play list.

While certain features of the invention have been illustrated as described herein, many modifications, substitutions, changes and equivalents will now occur to those skilled in the art. It is, therefore, to be understood that the appended claims are intended to cover all such embodiments and changes as fall within the true spirit of the invention.

What is claimed is:

1. A method comprising:
analyzing a play list of media titles and a profile of a media consumer; and
modifying the play list by inserting a reference to content into the play list, the content selected according to the media consumer profile and at least one of a first media title immediately preceding the reference to the content in the play list, and a second media title immediately following the reference to the content in the play list.

2. The method of claim 1 further comprising:
selecting the location at which to insert the reference to the content in the play list according to at least one insertion point.

3. The method of claim 2, wherein the at least one insertion point is determined by the media consumer.

4. The method of claim 2, further comprising determining the at least one insertion point.

5. The method of claim 1 wherein the media titles comprise digital music tracks and the content comprises at least one of a song, an advertisement, and a news item.

6. The method of claim 5, wherein the media titles and the content are represented in the MP3 audio format and accessible via the Internet.

7. The method of claim 1, further comprising:
providing the modified play list to a client of the media consumer.

8. The method of claim 1, further comprising:
providing value to the media consumer in return for acceptance of the modified play list.

9. The method of claim 1, wherein the profile comprises media consumer preferences for at least one of type of song, musical genre, type of news item, and other content and consumer interests.

10. The method of claim 1, further comprising:
providing value to a party for the right to modify the play list of the media consumer.

11. A method comprising:
receiving a play list of references to media titles, a profile, and identified insertion points for the play list, associated with a media consumer;
analyzing the play list and the profile of the media consumer; and
modifying the play list by adding a reference to content at a selected one of the identified insertion points according to the play list and profile.

12. The method of claim 11 further comprising:
selecting the reference to content according to at least one of a first media title immediately preceding the selected one of the acceptable insertion points in the play list, and a second media title immediately following the selected one of the acceptable insertion points in the play list.

13. The method of claim 11, wherein the media titles comprise digital music tracks and the content comprises at least one of a song, an advertisement, and a news item.

14. The method of claim 11, further comprising:
providing the modified play list to a client of the media consumer.

15. The method of claim 11, further comprising:
providing value to the media consumer in return for acceptance of the modified play list.

16. The method of claim 11, wherein the profile comprises media consumer preferences for at least one of type of song, musical genre, type of news item, and other content and consumer interests.

17. The method of claim 11, further comprising:
providing value to a party for the right to modify the play list of the media consumer.

18. An article comprising:
a machine-accessible medium comprising instructions which, when executed by a processor, cause the supplying of content by analyzing a play list of media titles and a profile of a media consumer, and modifying the play list by inserting a reference to content into the play list, the content selected according to the media consumer profile and at least one of a first media title immediately preceding the reference to the content in the play list, and a second media title immediately following the reference to the content in the play list.

19. The article of claim 18, further comprising instructions for selecting the location at which to insert the reference to the content in the play list according to at least one insertion point.

20. The article of claim 18, wherein the media titles comprises digital music tracks and the content comprises a t least one of a song, an advertisement, and a news item.

21. The article of claim 18, further comprising instructions for providing the modified play list to a client of the media consumer.

22. The article of claim 18, further comprising instructions for providing value to the media consumer in return for acceptance of the modified play list.

23. An article comprising:
a machine-accessible medium comprising instructions which, when executed by a processor, cause the supplying of content by receiving a play list of references to media titles, a profile, and identified insertion points for the play list, associated with a media consumer, analyzing the play list and the profile of the media consumer, and modifying the play list by adding a reference to content at a selected one of the identified insertion points according to the play list and profile.

24. The article of claim 23 further comprising instructions for selecting the reference to content according to at least one of a first media title immediately preceding the selected one of the acceptable insertion points in the play list, and a second media title immediately following the selected one of the acceptable insertion points in the play list.

25. The article of claim 23, wherein the media titles comprises digital music tracks and the content comprises at least one of a song, an advertisement, and a news item.

26. The article of claim 23, further comprising instructions for providing the modified play list to a client of the media consumer.

27. The article of claim 23, further comprising instructions for providing value to the media consumer in return for acceptance of the modified play list.

28. A system for supplying relevant content comprising:
a play list of references to media titles;
media files storing the media titles;
a profile of a media consumer; and
content selection logic to analyze the play list and the profile and to modify the play list by inserting a reference to content into the play list at an insertion point, the content selected according to the profile and at least one of a first media title immediately preceding the reference to the content in the play list, and a second media title immediately following the reference to the content in the play list.

29. The system of claim 28 wherein the media titles comprise digital music tracks and the content comprises at least one of a song, an advertisement, and a news item.

30. The system of claim 29, wherein the media titles and the content are represented in the MP3 audio format and the media files are accessible via the Internet.

31. The system of claim 30, further comprising a media player to render the media titles and the content referenced by the modified play list.

32. The system of claim 28, wherein the profile comprises media consumer preferences for at least one of type of song, musical genre, type of news item, and other content and consumer interests.
